(19) United States
(12) Patent Application Publication
(10) Pub. No.: US 2015/0298330 A1
(43) Pub. Date: Oct. 22, 2015

(54) CUTTER

(71) Applicant: Hsiu-Man YU CHEN, Taichung (TW)

(72) Inventor: Hsiu-Man YU CHEN, Taichung (TW)

(21) Appl. No.: 14/788,937

(22) Filed: Jul. 1, 2015

Related U.S. Application Data
(63) Continuation-in-part of application No. 13/724,845, filed on Dec. 21, 2012.

(51) Int. Cl. B26B 27/00

(52) U.S. Cl. CPC B26B 27/005

(57) ABSTRACT

A cutter includes a main body. The top edge of the main body is provided with a holding portion, and its two sides extend outward to form a pair of lugs. A pair of gaps is formed between the main body and the pair of lugs. The cutter further includes a cutting unit wrapped by the main body. The cutting unit has one side formed with a pointed end portion and another side formed with a cutter edge. The pointed end portion protrudes out of the holding portion, and the cutter edge is exposed out of the gaps. The multi-function cutter is able to cut and remove various packaging members easily and efficiently.

The current application is a continuation-in-part of U.S. application Ser. No. 13/724845 filed on Dec. 21, 2012.

### BACKGROUND OF THE INVENTION

1. Field of the Invention

The present invention relates to a cutter, and more particularly to a multi-function cutter able to cut off and remove various kinds of packaging members.

2. Description of the Prior Art

In general, for facilitating articles to be carried and transported, the articles are usually boxed or bagged for protection and, after the articles are packed in a box, and even the box itself is tied up by plastic packaging straps for insuring the articles to be kept intact in the box. For unsealing a packing box, a craft knife is often employed to cut off and remove every sort of packaging members fastened on the box and this method is unquestionable in point of technical level, but using the knife point to be a chief force-applying point of cutting will often cause injuries to the articles in the packing box. In addition, it is inconvenient to remove staples or plastic packaging straps from the packing box.

In view of the drawbacks mentioned above, a conventional cutter to enhance efficiency of removing packaging members is developed as disclosed in US Design No. D527604. Referring to FIG. 1, this conventional cutter has a blade 1. Two ends of the blade 1 are covered by lugs 2, 3 respectively. The central portion of the cutter edge of the blade 1 is covered by a grip 4. Thus, the blade 1 between the grip 4 and the two lugs 2, 3 is used to cut off and remove various packaging members, not using the cutter point of the cutter as a chief force-applying point of cutting. This cutter can prevent the cutter point from damaging the articles in the box and cut off and remove various kinds of packaging members to enhance efficiency of removal of packaging members. Furthermore, the grip 4 of the conventional cutter is bored with a through hole 5 for hanging the cutter to facilitate storage of the cutter.

As mentioned above, the conventional cutter carries out cutting not by the cutter point but by the blade 1 between the grip 4 and the two lugs 2, 3. The conventional cutter is unable to cut off packaging members that are seamless and completely and closely attached to the surface of a packing box.

Accordingly, the inventor of the present invention has devoted himself based on his many years of practical experiences to solve these problems.

### SUMMARY OF THE INVENTION

The primary object of the present invention is to provide a cutter which is able to cut off and remove various kinds of packaging members that are seamless and completely and closely attached to the surface of a packing box. The cutter is multi-function and able to enhance efficiency of removing packaging members.

In order to achieve the aforesaid object, the cutter comprises a main body. Two lengthwise ends of the main body are defined as a first end portion and a second send portion, respectively. The first end portion of the main body is provided with an accommodation space. A central portion of a top edge of the first end portion of the main body is provided with a first opening. The first opening is in communication with the accommodation space. The top edge of the first end portion is provided with a holding portion close to the circumferential side of the first opening. Two sides of the first end portion are provided with a pair of lugs extending outward. The main body has a pair of gaps formed between the first end portion and the pair of lugs and facing downward. A closed end of each of the pair of gaps is provided with a second opening. The second opening is in communication with the accommodation space. The cutter further comprises a cutting unit. The cutting unit is disposed in the accommodation space of the first end portion. The cutting unit generally has a triangular shape. The cutting unit has one side formed with a pointed end portion. The pointed end portion protrudes out of the first opening. Another side of the cutting unit, opposite to the pointed end portion, is formed with a cutter edge. The cutter edge is located at the gaps formed between the first end portion and the pair of lugs and protrudes out of the second opening. The cutting unit is provided with a plurality of penetrating holes. The cutting unit is integrally wrapped by the main body, leaving the pointed end portion and the cutter edge exposed.

The cutting unit wrapped by the main body has the cutter edge to carry out cutting of packaging members, avoiding any damages to the articles in a packing box. Packaging members that are seamless and have their edges closely attached to a packing box can be cut off by the pointed end portion of the cutter. This is able to cut and remove various packaging members easily and efficiently. The pointed end portion of the cutter can be used to pull up and remove staples from a packing box, enhancing efficiency of removing packaging members from a packing box. The cutter is a multi-function cutter able to cut off and remove various kinds of packaging members.

### BRIEF DESCRIPTION OF THE DRAWINGS

FIG. 1 is a perspective view of a conventional cutter;

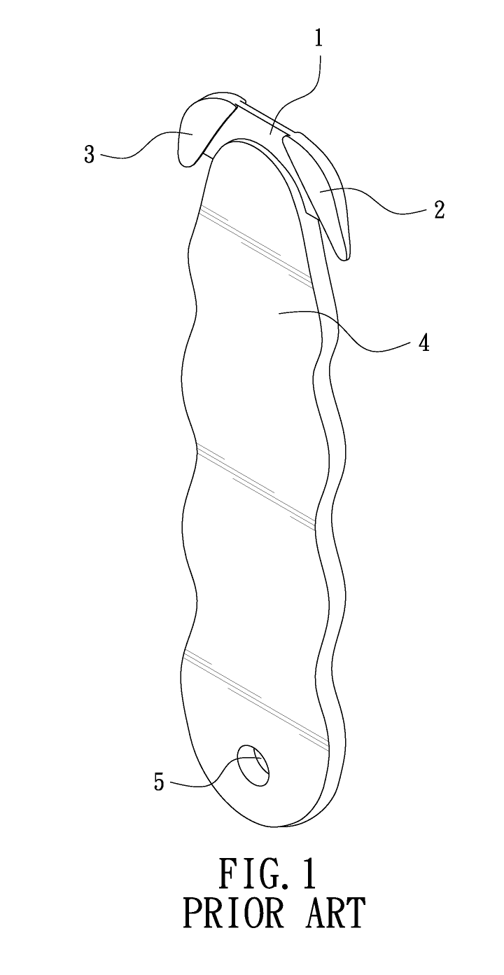

FIG. 2 is a perspective view according to a first embodiment of the present invention;

FIG. 3 is a perspective view showing a cutting unit according to the first embodiment of the present invention;

FIG. 4 is a longitudinal sectional view according to the first embodiment of the present invention;

FIG. 5 is a transverse sectional view according to the first embodiment of the present invention;

FIG. 6 is a schematic view of the cutter in a first use state according to the first embodiment of the present invention, illustrating that the cutter is used to unseal a packing box in one way;

FIG. 7 is a schematic view of the cutter in a second use state according to the first embodiment of the present invention, illustrating that the cutter is used to unseal a packing box in another way;

FIG. 8 is a schematic view of the cutter in a third use state according to the first embodiment of the present invention, illustrating that the cutter is used to pull out staples and unseal a packing box in one way;

FIG. 9 is a schematic view of the cutter in a fourth use state according to the first embodiment of the present invention, illustrating that the cutter is used to pull out staples and unseal a packing box in another way;

FIG. 10 is a schematic view of the cutter in an operation state according to the first embodiment of the present invention, showing a way of holding and operating the cutter;

FIG. 11 is a schematic view of the cutter in an operation state according to the first embodiment of the present invention, showing another way of holding and operating the cutter; and

FIG. 12 is a perspective view according to a second embodiment of the present invention.

### DETAILED DESCRIPTION OF THE PREFERRED EMBODIMENTS

Embodiments of the present invention will now be described, by way of example only, with reference to the accompanying drawings.

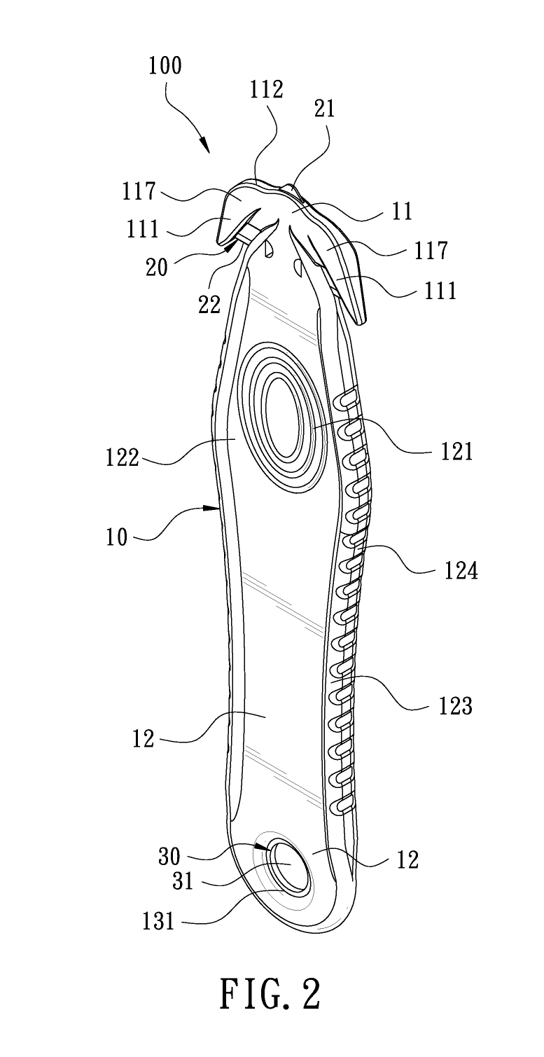

FIG. 2 is a perspective view according to a first embodiment of the present invention. The present invention discloses a cutter 100. The cutter 100 comprises a main body 10, a cutting unit 20, and a magnetic member 30.

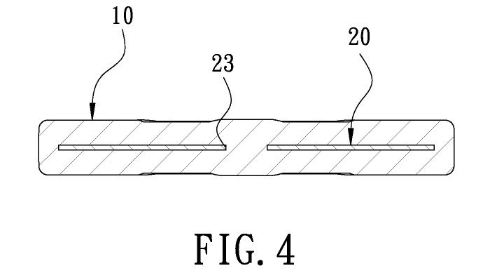

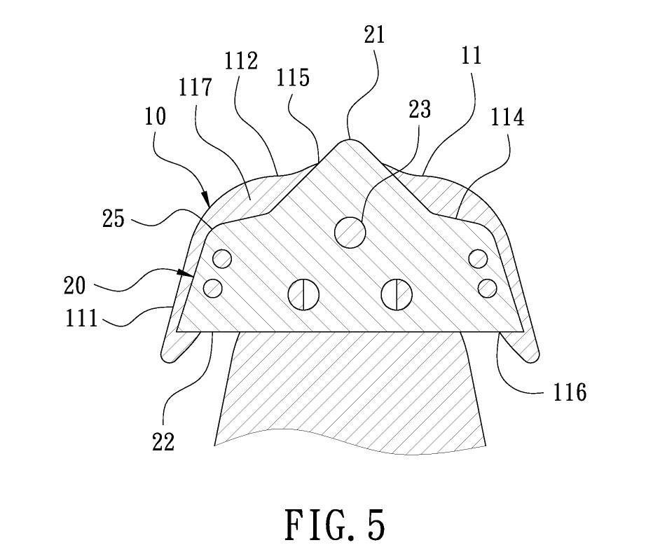

The main body 10 is an elongate plate body made of plastic. Two lengthwise ends of the main body 10 are defined as a first end portion 11 and a second send portion 12, respectively. Referring to FIG. 4 and FIG. 5, the first end portion 11 of the main body 10 is provided with an accommodation space 114. A central portion of a top edge of the first end portion 11 of the main body 10 is provided with a first opening 115. The first opening 115 is in communication with the accommodation space 114. The first end portion 11 of the main body 10 is gradually reduced toward the top edge thereof. The top edge of the first end portion 11 is provided with a holding portion 112 close to the circumferential side of the first opening 115. The holding portion 112 is a holding surface. Two sides of the first end portion 11 are provided with a pair of lugs 111 extending outward and downward and a pair of shoulder portions 117 integrally formed with the pair of lugs 111. The main body 10 has a pair of gaps formed between the first end portion 11 and the pair of lugs 11 and facing downward. A closed end of each of the pair of gaps is provided with a second opening 116. The second opening 116 is in communication with the accommodation space 114. Front and rear surfaces of the main body 10, between the first end portion 11 and the second end portion 12, are provided with anti-skid portions 121 each composed of a plurality of concentric and oval-shaped raised rings. The main body 10, between the first end portion 11 and the second end portion 12, is gradually reduced from its central portion toward the two lengthwise ends to define a stop portion 122 between the first end portion 11 and the second end portion 12. The outer edges of the two surfaces of the main body 10, between the first end portion 11 and the second end portion 12, are provided with protruding stop edges 123. The thickness of the stop edges 123 is greater than that of the anti-skid portions 121. The outer side of each stop edge 123 is provided with a plurality of anti-skid blocks 124. The second end portion 12 is provided with a through hole 131.

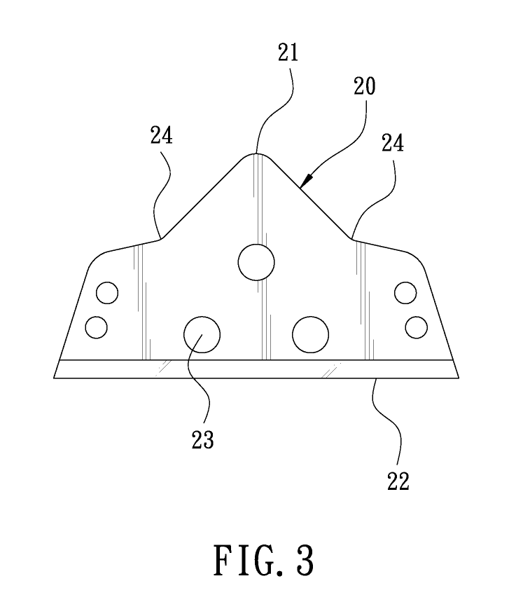

The cutting unit 20 is disposed in the accommodation space 114 of the first end portion 11. Referring to FIG. 3, in this embodiment of the present invention, the cutting unit 20 is generally a triangular metal plate. The cutting unit 20 has one side formed with a pointed end portion 21. The pointed end portion 21 is platy and has two working surfaces substantially parallel with each other and side edges between the two working surfaces. The pointed end portion 21 protrudes out of the first opening 115 and the holding portion 112. Two sides of the cutting unit 20, adjacent to the pointed end portion 21, have notches 24. Another side of the cutting unit 20, opposite to the pointed end portion 21, is formed with a cutter edge 22. The cutter edge 22 is located at the gaps formed between the first end portion 11 and the pair of lugs 111, and protrudes out of the second opening 116. The cutting unit 20 is provided with a plurality of penetrating holes 23. The cutting unit 20 is almost wrapped by the main body 10, leaving the pointed end portion 21 and the cutter edge 22 exposed. The notches 24 are covered by the main body 10. The notches 24 are formed at the position where the lugs 111 are connected with the shoulder portions 117. The pointed end portion 21 is located at the central portion of the top edge of the first end portion 11. The cutter edge 22 is located at the gaps formed between the first end portion 11 and the pair of lugs 111.

The magnetic member 30 is disposed at the second end portion 12. The magnetic member 30 is an iron sheet. The magnetic member 30 has a penetrating hole 31 corresponding in position to the through hole 131, enabling the penetrating hole 31 to communicate with the through hole 131. The magnetic member 30 is integrally wrapped by the main body 10, leaving an inner side edge exposed.

Referring to FIG. 2 and FIG. 3, the main body 10 is integrally formed to wrap both the cutting unit 20 and the magnetic member 30, so the main body 10 can be produced quickly and has a low cost. The first end portion 11 of the main body 10 is gradually reduced toward its top edge. The top edge of the first end portion 11 is formed with the pointed end portion 21. The cutter edge 22 is disposed between the first end portion 11 and the pair of lugs 111. The cutter is to employ the cutter edge 22 to cut off various packaging members but not employ the cutter point to be a chief force-applying point of cutting, able to avoid damaging the articles in a packing box. Furthermore, when the main body 10 is integrally covered on the cutting unit 20, the penetrating holes 23 of the cutting unit 20 function to reinforce the combination between the cutting unit 20 and the main body 10. Through the shoulder portions 117, the structural strength of the lugs 111 is enhanced. It is noted that the cutting unit 20 is substantially in a triangle shape. Therefore, when the pointed end portion 21 of the cutting unit 20 is operated to remove packaging members, the stress of the pointed end portion 21 can be distributed evenly, enabling the cutting unit 20 to bear a greater acting force.

Referring to FIG. 2, the two surfaces of the main body 10, between the first end portion 11 and the second end portion 12, are provided with the anti-skid portions 121, respectively. When the user holds and employs the cutter 100, the anti-skid portions 121 prevent the cutter 100 from slipping off the user's hand. Additionally, the outer edges of the two surfaces of the main body 10, between the first end portion 11 and the second end portion 12, are provided with the protruding stop edges 123, respectively. The thickness of the stop edges 123 is greater than that of the anti-skid portions 121. Thus, slipping between the cutter 100 and the user's hand can be avoided via both the anti-skid portions 121 and the stop edges 123. When using the cutter 100, the user can press and hold the stop portions 122 and the stop edges 123 to increase utility of applying force, and the anti-skid blocks 124 provided on the outer sides of the stop edges 123 function to prevent the cutter 100 from slipping off the user's hand.

In the embodiment of the present invention, the magnetic member 30 is an iron sheet with an exposed inner side edge, not only reinforcing the structure of the cutter 100 but also facilitating the cutter 100 to be picked up by magnet. The magnetic member 30 is provided with the penetrating hole 31 communicating with the through hole 131 of the second end portion 13 for hanging the cutter 100 and facilitating storage of the cutter 100 by using magnet to attract the iron sheet.

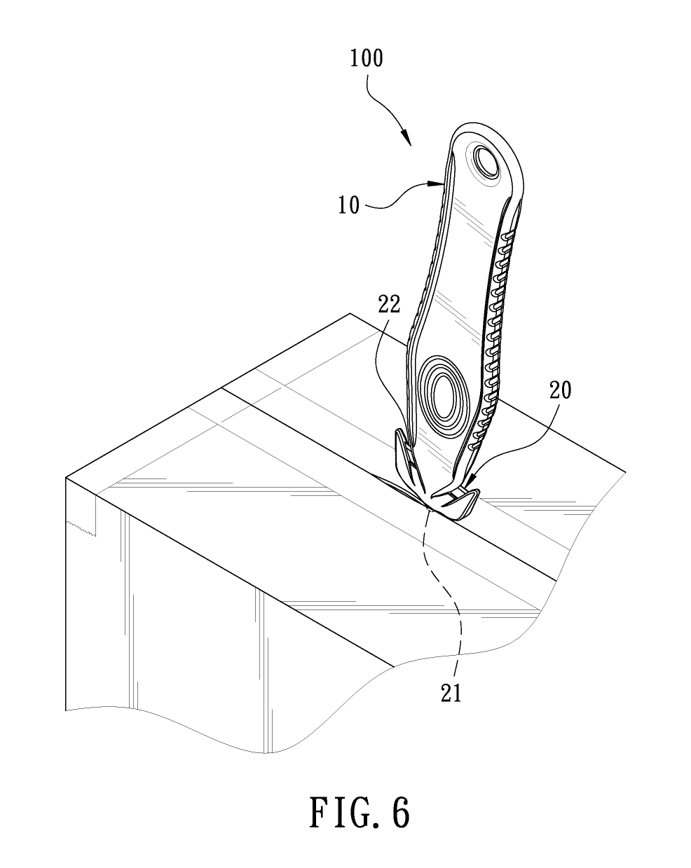

FIG. 6 is a schematic view of the cutter in a first use state according to the first embodiment of the present invention, illustrating that the cutter is used to unseal a packing box in one way. Packaging members that are seamless and have their edges closely attached to a packing box can be cut off by the pointed end portion 21 of the cutter 100. Thus, the cutter 100 of the present invention can easily cut and remove the packaging members that cannot be cut and removed by the cutter edge 22 of the present invention. Through the holding portion 112 to hold against the surface of an article, the pointed end portion 21 has a working width able to penetrate the article so as to limit the penetration and cutting depth of the pointed end portion 21.

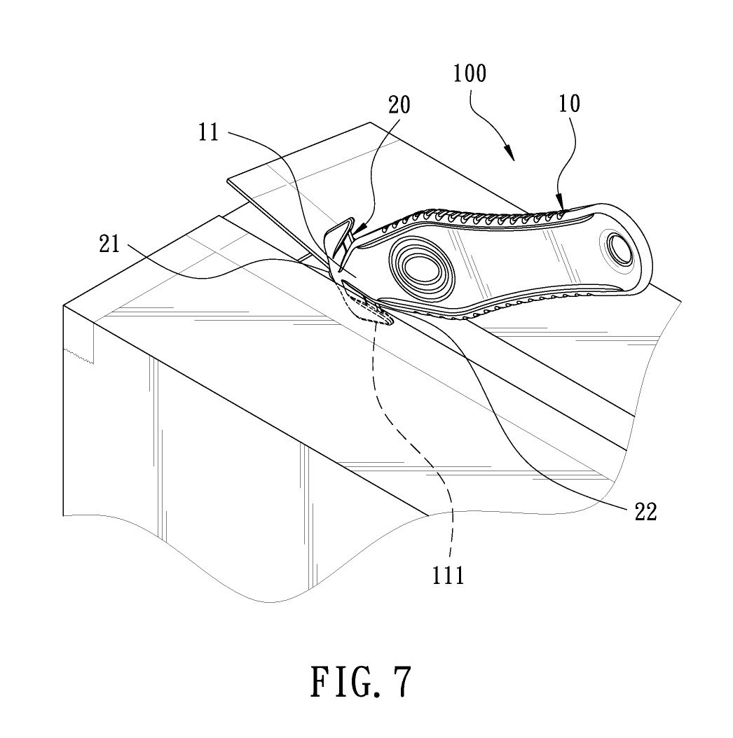

FIG. 7 is a schematic view of the cutter in a second use state according to the first embodiment of the present invention, illustrating that the cutter is used to unseal a packing box in another way. The cutting unit 20 wrapped by the main body 10 has the exposed cutter edge 22 between the first end portion 11 and the two lugs 111 of the main body 10 to carry out cutting of packaging members without using the cutter point as a chief force-applying point of cutting, avoiding any damages to the articles in a packing box. This is able to cut and remove various packaging members easily and efficiently, such as adhesive tapes and the like. Apart from being able to cut off all sorts of packaging members with ease, the cutter edge 22 of the cutter 100 of the present invention can also be employed to directly cut open a cardboard box without damaging the articles therein.

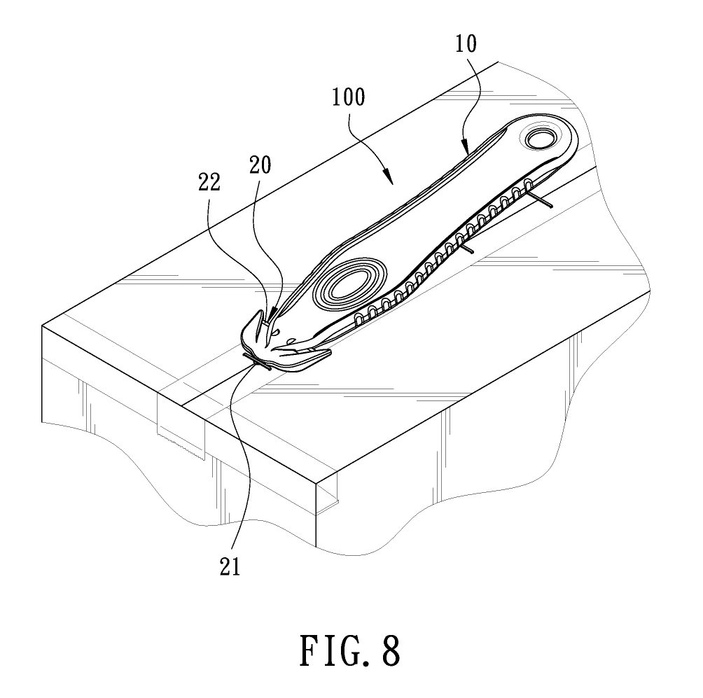

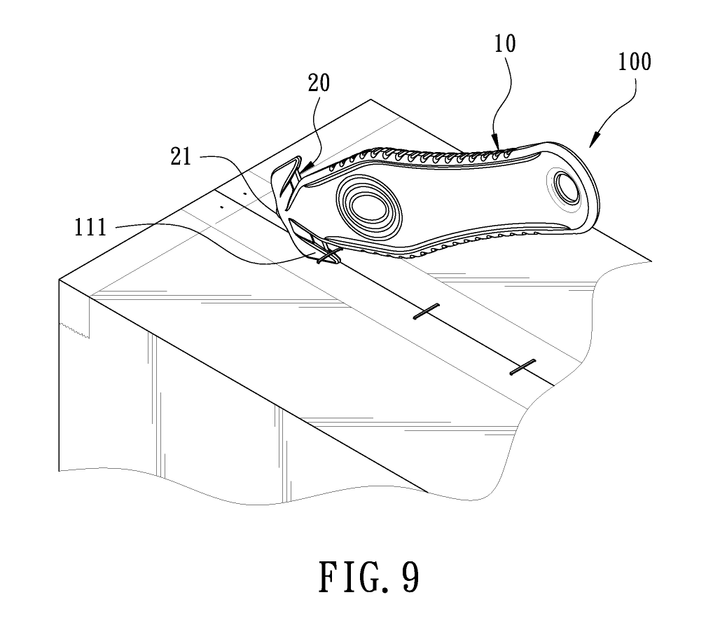

FIGS. 8 and 9 show a third and a fourth use state of the cutter 100 of the present invention. The pointed end portion 21 of the cutter 100 can be used to pull up and remove staples from a packing box and, since the cutting unit 20 is triangle-shaped, when the pointed end portion 21 pulls up the staple of the box, the stress of the pointed end portion 21 can be dispersed, enabling the cutting unit 20 to bear greater acting force. In addition, staples fastened on a packing box can also be pulled up by the lugs 111 in cooperation with the pointed end portion 21 of the cutter 100, enhancing efficiency of removing packaging members from a packing box.

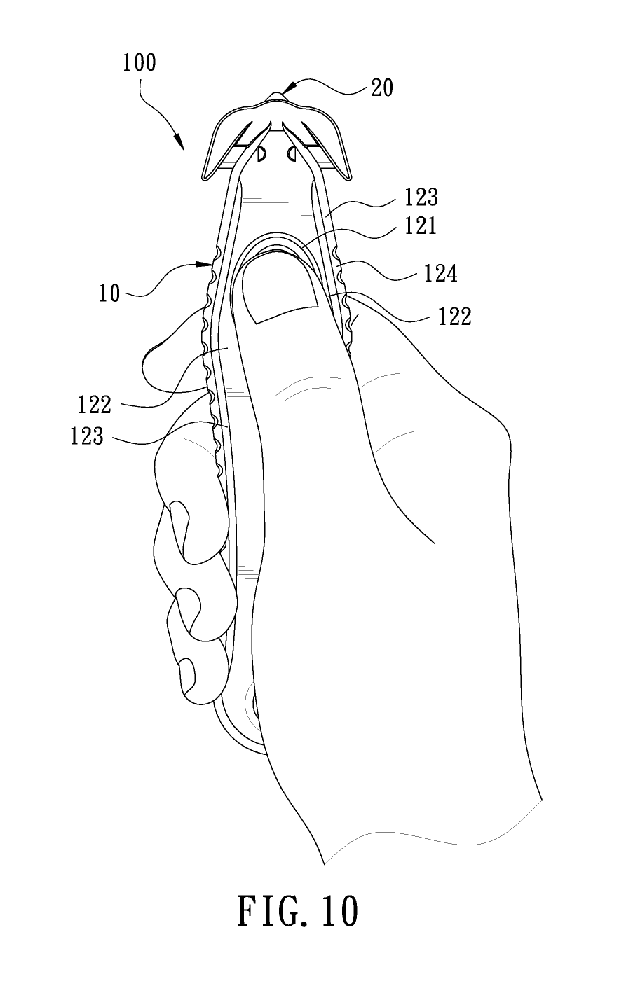

FIG. 10 shows a holding and operating state of the cutter 100 of the present invention. When holding and using the cutter 100, the user can press the anti-skid portions 121 of the cutter 100 to enhance stopping effect and increase force application, and the stop edges 123 provided at the outer side edges of the two surfaces of the main body 10 between the first end portion 11 and the second end portion 12 further function to enhance stopping effect for avoiding slipping of the cutter 100 when the user holds and employs the cutter 100.

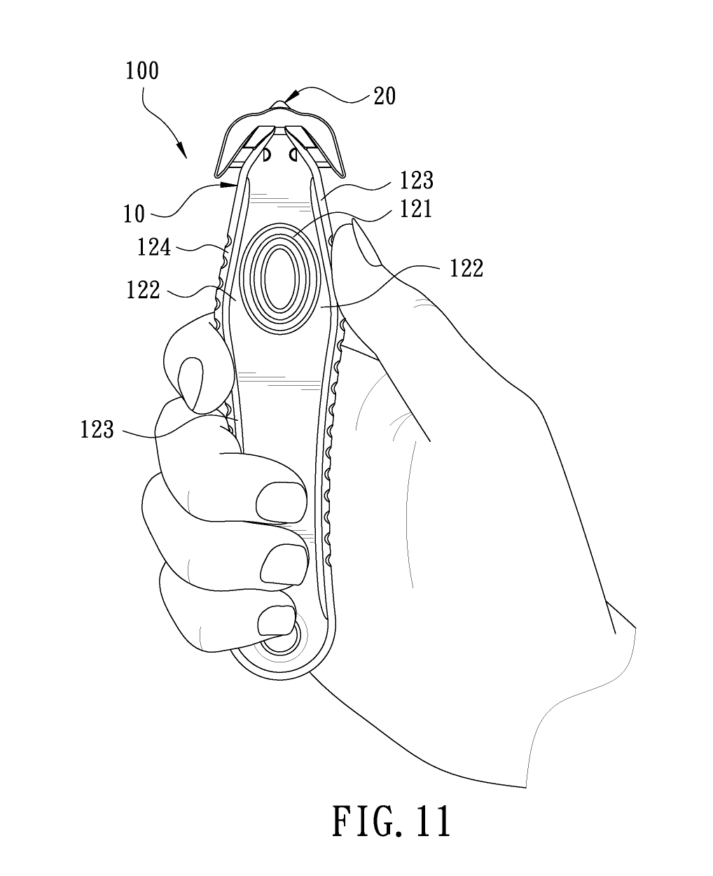

FIG. 11 shows another holding and operating state of the cutter 100 of the present invention. When holding and using the cutter 100, the user can press the stop portions 122 to force the lugs 111 to pierce into a packaging member and have the cutter edge 22 removing the packaging member from a packing box, and the anti-skid blocks 124 on the outer sides of the stop edges 123 function to reinforce stopping effect for avoiding the cutter 100 slipping off the user's hand.

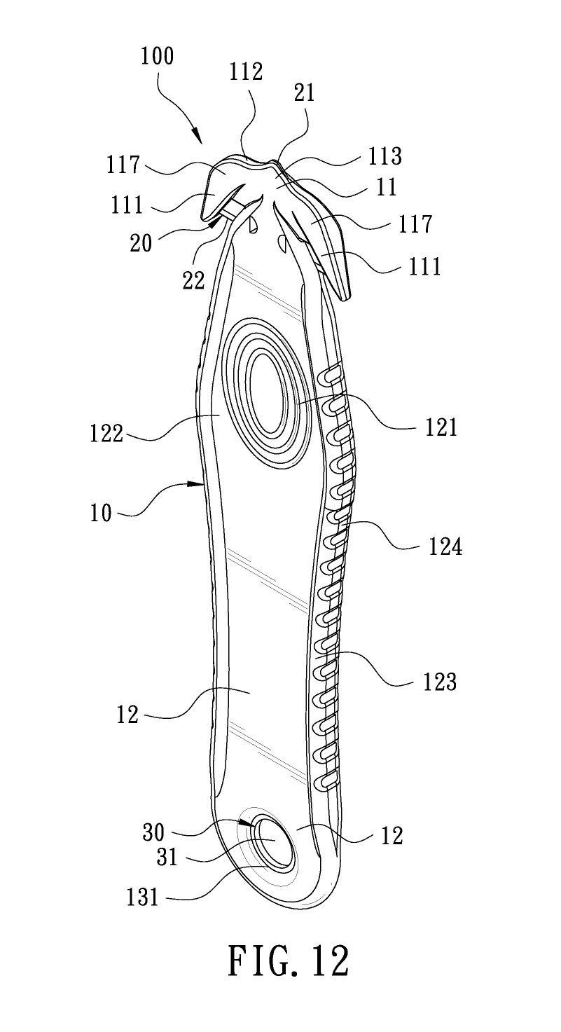

FIG. 12 is a perspective view according to a second embodiment of the present invention. The second embodiment is substantially similar to the first embodiment with the exceptions described hereinafter. Front and rear surfaces of the first end portion 11, relative to the working surfaces of the pointed end portion 21 of the cutting unit 20, are provided with protection lids 113. The protection lids 113 each are slightly less than the working surfaces of the pointed end portion 21 of the cutting unit 20, such that at least one side edge of the pointed end portion 21 of the cutting unit 20 is exposed to be a V-shaped working surface.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cutter, comprising:
a main body, the main body being a plate body, two lengthwise ends of the main body being defined as a first end portion and a second send portion respectively, the first end portion of the main body being provided with an accommodation space, a central portion of a top edge of the first end portion of the main body being provided with a first opening, the first opening being in communication with the accommodation space, two sides of the first end portion being provided with a pair of lugs extending outward, the main body having a pair of gaps formed between the first end portion and the pair of lugs and facing downward, a closed end of each of the pair of gaps being provided with a second opening, the second opening being in communication with the accommodation space; and
a cutting unit, the cutting unit being platy and disposed in the accommodation space of the first end portion, the cutting unit generally having a triangular shape, the cutting unit having one side formed with a pointed end portion, the pointed end portion protruding out of the first opening, another side of the cutting unit, opposite to the pointed end portion, being formed with a cutter edge, the cutter edge being located at the gaps formed between the first end portion and the pair of lugs and protruding out of the second opening, the cutting unit being provided with a plurality of penetrating holes, the cutting unit being integrally wrapped by the main body, leaving the pointed end portion and the cutter edge exposed;
wherein the top edge of the first end portion is provided with a holding portion close to a circumferential side of the first opening, and the holding portion is adapted to hold against a surface of an article so that the pointed end portion has a working width able to penetrate the article;
thereby, by the holding portion, the pointed end portion is used to carry out penetration and cutting and the depth of penetration and cutting of the pointed end portion can be limited.

2. The cutter as claimed in claim 1, wherein two sides of the cutting unit, adjacent to the pointed end portion, have notches, the notches are covered by the main body, the main body is provided with a pair of shoulder portions integrally formed with the pair of lugs, and the shoulder portions correspond in position to the notches.

3. The cutter as claimed in claim 1, wherein the pointed end portion of the cutting unit is platy, and the pointed end portion of the cutting unit has two working surfaces substantially parallel with each other and side edges between the two working surfaces.

4. The cutter as claimed in claim 3, wherein two surfaces of the first end portion, relative to the working surfaces of the pointed end portion of the cutting unit, are provided with protection lids, and at least one side edge of the pointed end portion of the cutting unit is exposed.

5. The cutter as claimed in claim 4, wherein the protection lids each are slightly less than the working surfaces of the pointed end portion of the cutting unit, such that the working surfaces of the pointed end portion become V-shaped.

6. The cutter as claimed in claim 5, wherein the first end portion is gradually reduced toward the top edge thereof.
